(19) United States
(12) Patent Application Publication
(10) Pub. No.: US 2010/0206834 A1
(43) Pub. Date: Aug. 19, 2010

(54) CHEMICAL REACTOR WITH PRESSURE RELEASE

(75) Inventor: Weimin Qian, Waterford, CT (US)

Correspondence Address: LAW OFFICE OF MICHAEL A. BLAKE, LLC, 95 HIGH STREET, SUITE 5, MILFORD, CT, 06460, US

(73) Assignee: Q LABTECH LLC, Waterford, CT (US)

(21) Appl. No.: 12/667,164

(22) PCT Filed: Sep. 11, 2008
(86) PCT No.: PCT/US2008/076037

§ 371 Date: Dec. 29, 2009

Related U.S. Application Data
(63) Continuation-in-part of application No. 11/853,915, filed on Sep. 12, 2007.
(60) Provisional application No. 61/076,593, filed on Jun. 27, 2008.

(51) Int. Cl. B65D 51/00; B01J 19/00; G05D 16/00

(52) U.S. Cl. 215/247; 422/130; 422/112

(57) ABSTRACT

The disclosed invention relates to a reaction bottle comprising a container with a container opening and a container interior, a septum associated with the container and configured to releasably seal the container opening, a needle holder associated with the container, the needle holder defining a holder cavity, a needle associated with the needle holder, the needle disposed at least partially within the holder cavity, wherein the septum is deformable between a sealing rest state and a punctured state, and the septum is deformable into puncturable impingement with an end of the needle when the septum is in the punctured state.

### CROSS REFERENCE TO RELATED APPLICATIONS

The present invention is related to U.S. patent application Ser. No. 11/853,915, filed on Sep. 12, 2007. This application is a “continuation in part” of U.S. patent application Ser. No. 11/853,915 (Reaction bottle with Pressure Release), filed on Sep. 12, 2007. This application further claims the benefit of U.S. Provisional Application Ser. No. 61/076,593 filed on Jun. 27, 2008. The entire contents of both are hereby incorporated by reference.

### TECHNICAL FIELD

The present invention relates to the use of a resealed reaction bottle to carry out chemical reactions with a safe pressure release mechanism.

### BACKGROUND

It is conventional to carry out chemical reaction in a glass reaction bottle with an open end. Based on Collision Theory and Activation Energy Theory (minimum kinetic energy), as a rule of thumb, reaction rates for many reactions double or triple for every 10 degree Celsius increase in temperature. Thus heating is often required for increasing rate of chemical reactions or starting and continuing a chemical reaction. When heating is required for a reaction bottle with an open end, a cooling condenser usually is used to restrain the loss of reactants, products, reagents and solvent from the reaction bottle. Even with a cooling condenser, some portion of the reactants may be lost prior to the chemical reaction due to vaporization of the reactants, which may lead to retardation of the desired chemical reaction. Usually the temperature limit for a chemical reaction is the boiling temperature of the reactants and/or solvents used in an open vessel. When higher than boiling temperature is required for certain reactions, or if volatile reactants are involved, or pressure is required for a gaseous reaction, then one may utilize a pressure vessel (such as a glass pressure bottle, a glass pressure tube, and/or a sealed tube), or metal pressure reactor to carry out these reactions. One of the drawbacks associated with using a pressure vessel is safety. Although some pressure vessels are equipped with pressure gauges for monitoring purposes, they usually lack automatic venting systems. Pressure vessels have been known to explode due to unpredictable sudden excess pressure in the pressure vessel. Another drawback is that a pressure vessel may be very difficult to open after a chemical reaction due to internal pressure in the vessel which can cause injury to chemists. One of the drawbacks associated with metal pressure reactors is that they cannot carry out reactions with acidic materials. Acidic materials may be a reactant, product, reagent or solvent (like hydrogen chloride) in a chemical reaction. Acidic materials lead to corrosion, which in turn can cause unpredictable leaks and injury under high temperature and high pressure. In addition a metal pressure reactor should not be used to carry out reactions with reagents that are sensitive to metals. Another drawback to metal pressure reactors, is that they need special skill to use and maintain properly.

Thus, due to the aforementioned disadvantages and drawbacks, there is a need for a reaction bottle that allows for releasing excess pressure safely, while generally maintaining a seal of the reaction bottle during chemical reactions.

### SUMMARY

The disclosed invention relates to a reaction bottle comprising a container with a container opening and a container interior, a septum associated with the container and configured to releasably seal the container opening, a needle holder associated with the container, the needle holder defining a holder cavity, a needle associated with the needle holder, the needle disposed at least partially within the holder cavity, wherein the septum is deformable between a sealing rest state and a punctured state, and the septum is deformable into puncturable impingement with an end of the needle when the septum is in the punctured state.

The disclosed invention also relates to a needle puncturing device, comprising a needle adapter containing a protruding member, a needle associated with the needle adapter, a container adapter containing at least one slot, the container adapter being configured to associate the needle adapter with a container, wherein the protruding member is associated with the slot so as to position the needle in proximity to the container.

In addition, the disclosed invention relates to a reaction system comprising a container defining a container opening and a container interior, a septum associated with the container and configured to releasably seal the container opening, a needle adapter containing a protruding member, the needle adapter defining a holder cavity, a needle associated with the needle adapter, the needle disposed at least partially within the holder cavity, a container adapter containing at least one slot, the container adapter being configured to associate said needle adapter with said container, wherein the protruding member is associated with the slot so as to position the needle in proximity to the container, and wherein the septum is deformable between a sealing rest state and a punctured state, the septum being deformable into puncturable impingement with an end of the needle when the septum is in the punctured state.

### BRIEF DESCRIPTION OF THE DRAWINGS

The present disclosure will be better understood by those skilled in the pertinent art by referencing the accompanying drawings, where like elements are numbered alike in the several figures, in which:

FIG. 1 is a front sectional view of one embodiment of the disclosed reaction bottle;

FIG. 2 is a front sectional view of the reaction bottle from FIG. 1, with the septa being deformed;

FIG. 3 is a front sectional view of the reaction bottle from FIGS. 1 and 2, with the septa back at an at rest state;

FIG. 4 is a front sectional view of another embodiment the disclosed reaction bottle;

FIG. 5 is a front sectional view of the disclosed reaction bottle from FIG. 4, with the septa deformed and a needle pierced through septa;

FIG. 6 is a front sectional view of another embodiment of the disclosed reaction bottle;

FIG. 7 is a perspective exploded view of the disclosed reaction bottle;

FIG. 8 is a perspective exploded view of a disclosed reaction bottle with a septum cap;

FIG. 9 is a generally front sectional view of the reaction bottle from FIG. 8;

FIG. 10 is a perspective exploded view of a reaction bottle, with a septum cap and where the container has a lip;

FIG. 11 is a generally front sectional view of the reaction bottle from FIG. 10;

FIG. 12 is a perspective exploded view of a reaction bottle with no septum cap and where the container has a lip located near the container opening; and

FIG. 13 is a generally front sectional view of the reaction bottle from FIG. 12.

FIG. 14A shows a sectional view of the reactor.

FIG. 14B shows a sectional view of the disclosed reactor during a reaction.

FIG. 14C shows a three-dimension view of an embodiment of a container adaptor.

FIG. 15 shows an embodiment of the reactor.

FIG. 16 shows another embodiment of the reactor.

FIG. 17 shows another embodiment of the reactor.

FIG. 18 is a front sectional view of another embodiment of the reactor.

FIG. 19A shows another embodiment of the reactor.

FIG. 19B shows an embodiment of the reactor during a reaction.

### DETAILED DESCRIPTION

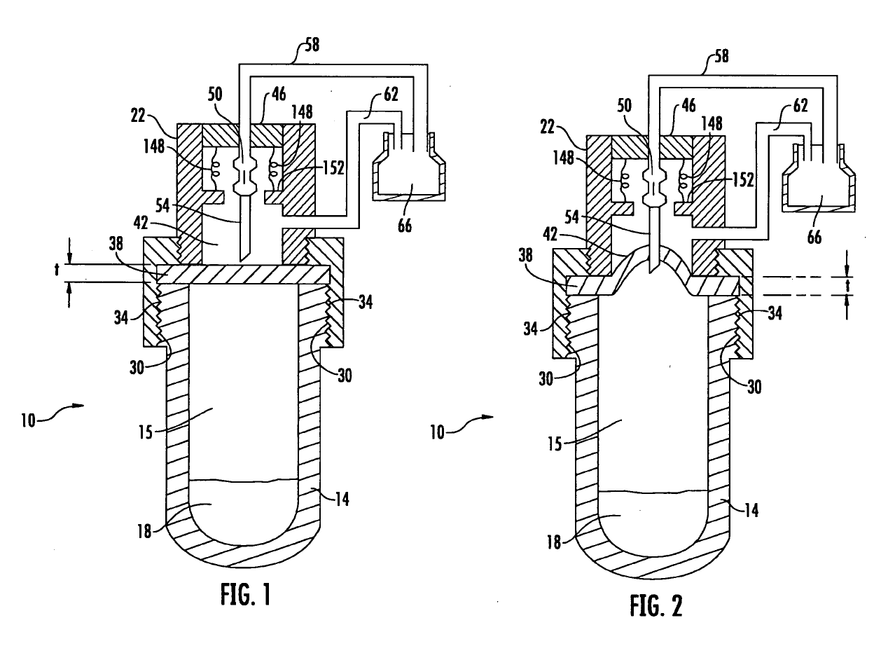

FIG. 1 is a front sectional view of the disclosed reaction bottle 10. The reaction bottle comprises a container 14. Reactants 18 are shown inside the container 14. The container 14 has a container top 26. A bottle cap 22 is attached to the container top 26. The bottle cap 22 may comprise a threaded interior surface 30 that has a generally cylindrical shape. The top exterior surface of the bottle 10 may have a threaded surface 34 and also a generally cylindrical shape. The cap 22 may thus be removeably attached to the container by mating the threaded interior surface 30 to the threaded surface 34. Located adjacent to the cap 22 and the container 14 is a septa 38. The septa is not attached to the cap 22 or container 14, thus allowing for easy replacement after each reaction, if desired, and also allows for avoidance of contamination. The septa 38 can be replaced after every reaction. When the cap 22 is attached to the container 14, the septa 38 divides a container interior 15 from a cap cavity 42 inside the bottle cap 22. The septa 38 may be made out of a variety of materials, such as but not limited to: Septum, PTFE-faced Silicone, model no. LG-4342, sold by Wilmad-LabGlass, 1002 Harding Highway, Buena, N.J. 08310-0688; PTFE/Red Rubber Septa, PTFE/Silicone/PTFE Septa, Pre-Slit PTFE/Silicone Septa, Pre-Slit PTFE/Red Rubber Septa, PTFE Septa, PTFE/Silicone Septa, Polyethylene Septa, Polypropylene Septa, Viton® Septa, HEADSPACE 20 MM SEPTA, Natural PTFE/White Silicone Septa, Ivory PTFE/Red Rubber Septa, Gray PTFE/Black Butyl Molded Septa all sold by National Scientific Company, Part of Thermo Fisher Scientific, 197 Cardiff Valley Road, Rockwood, Tenn. 37854; PTFE/Red Rubber PTFE/Grey Butyl PTFE/Silicone PTFE/Silicone, PTFE/Silicone, PTFE/Silicone, PTFE/Moulded Butyl, PTFE/Silicone all sold by SMI-LabHut Ltd., The Granary, The Steadings Business Centre, Maisemore, Gloucestershire, GL2 8EY, UK; and LabPure® Vial Septa sold by Saint-Gobain Performance Plastics, 11 Sicho Drive, Poestenkill, N.Y. 12140. Attached to the cap top 46 of the bottle cap 22 is a needle holder 50. Attached to the needle holder, is a non-coring hollow needle 54, configured to be located within the cap cavity 42. The needle holder 50 is in fluid communication with a needle conduit 58. The needle conduit 58 is also in fluid communication with the interior of the hollow needle 54 and the cap cavity 42. An optional emergency discharge conduit 62 may be attached to the bottle cap 22 and also be in fluid communication with the cap cavity 42. An optional reservoir 66 may be in fluid communication with the needle conduit 58. If the optional discharge conduit 62 is present, the reservoir 66 may be also be in fluid communication with the discharge conduit. The septa 38 is shown at an at rest state in FIG. 1. That is, the septa 38 has not been deformed yet by pressure in the container interior 15. In one alternative embodiment, the cap top 46 may move relative to the rest of the cap 22. One or more compression springs 148 are in compression against the underside of the cap top, and one or more cap extending members 152. In this alternative embodiment, a user may push the needle holder 50 down into the septum 38 manually, thereby releasing any pressure in the container 14. This release of pressure is a safety benefit of the disclosed invention. The compression springs 148 will tend to push the needle 54 up and away from the septum 38 after the user has pushed the needle 54.

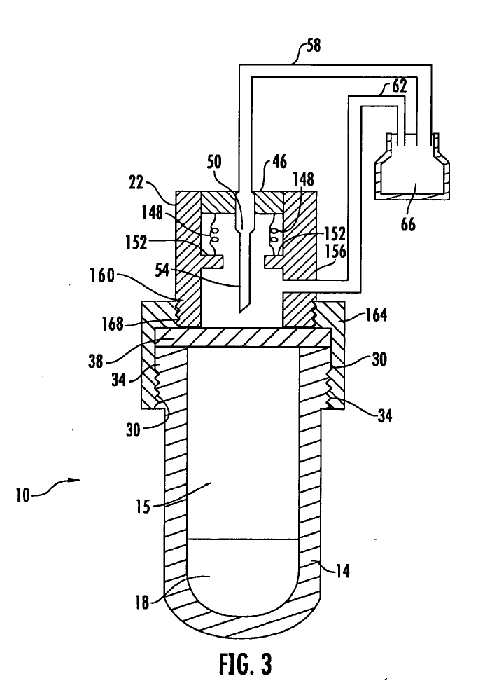

FIG. 2 shows a front sectional view of the disclosed reaction bottle 10 from FIG. 1. However, in this view, pressure in the container 14 is building up. The pressure may be building up due to chemical reactions occurring in the reactant 18, and/or pressure may be building up due to the interior of the container 14 being heated by microwave radiation or another heat source. If the pressure is great enough in the interior of the container 14, the septa 38 may deform up into the cap cavity 42. The septa may be configured to deform when the pressure in the reaction bottle is between 150-300 psi. Of course, the septa may configured to deform at other pressures, depending on the proposed chemical reactions. Also, the thinner the septa, the more deformation and the less pressure it can hold. As the septa 38 deforms it impinges the needle 54. Once the needle punctures the inner surface 70 of the septa 38, the interior of the hollow needle 54 is in fluid communication with the interior of the container 14. The pressure in the container interior 15 has reached a first threshold value when the pressure causes the septa 38 to become punctured by the hollow needle 54. The amount of pressure required to deform the septa 70 such that the needle 54 punctures the inner surface 70 is dependent on the thickness “t” of the septa and the particular material selected for the septa 38. The septa 38 is shown in a punctured state in FIG. 2.

FIG. 3 shows a front sectional view of the disclosed reaction bottle 10 from FIGS. 1 and 2. In this view, the pressure in the container 14 has been released by the puncturing action of the septa 38 impinging against the needle 54, and the pressurized fluid exiting the container through the needle 54, and into the needle conduit 58 and out to the atmosphere or to an optional reservoir 66. Since the pressure in the container 14 has been released, the septa 38 returns to its original shape, and is no longer impinging on the needle 54. The septa 38 is made out of a material, such as but not limited to PTFE-faced Silicone. This material, and others, allow the puncture hole in the septa 38 (from the needle 54) to reseal. The material allows for multiple resealing events. The septa 38 has returned to an at rest state. When the septa 38 has returned to an at rest state, the pressure in the container interior 15 has reached a second threshold value. The septa 38 is designed to reseal many times, usually at least 5 times, and up to 30 times or more, depending on the size of the non-coring needle.

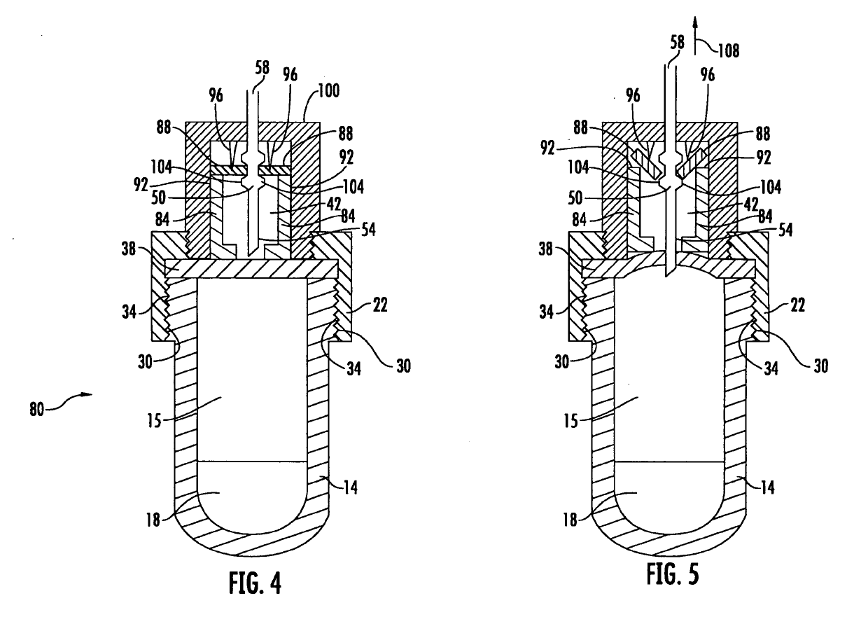

FIG. 4 shows another embodiment of the disclosed reaction bottle. In this embodiment the bottle 80 comprises a bottle cap 22 and a container 14. The bottle cap 22 may comprise a threaded interior surface 30 that has a generally cylindrical shape. The top exterior surface of the bottle 10 may have a threaded surface 34 and also a generally cylindrical shape. The cap 22 may thus be removeably attached to the container by mating the threaded interior surface 30 to the threaded surface 34. Located between the cap 22 and the container 14 is a septa 38. When the cap 22 is attached to the container 14, the septa 38 divides the interior of the container 14 from a cap cavity 42 inside the bottle cap 22. The bottle cap comprises at least one linearly moveable member 84 (this embodiment shows 2 linearly moveable members 84) located in the cap cavity 42. In communication with the top end 92 of the linearly moveable member 84 is a pivoting member 88. The pivoting member 88 is configured to pivot about a pivot member 96. The pivot member is fixed to the top 100 of the bottle cap 22. The pivot may have a spring mechanism to return member 84 to original position after pressure release (the spring mechanism is not shown in this figure). The hollow needle 54 is attached to a needle holder 50. In this embodiment, the needle holder 50 and needle 54 are linearly moveably with respect to the bottle cap, and can move up in the direction of the arrow 108, and down in a direction opposite the arrow 108. Fixed to the needle holder is at least one extended member 104 (in this embodiment, two or more extended members 104 are attached to the needle holder 50). The pivoting member 88 is configured to be in operational communication with the extended member 104. FIG. 5 shows the reaction bottle with pressure developing within the container 14. The pressure causes the septa 38 to deform and move away from the container 14 and into the cap cavity 42. As the septa 38 moves into the cap cavity 42, the septa 38 impinges against the linearly moveable member 84, causing the linearly moveable member 84 to move up in the direction of the arrow 108. The upwards movement of the linearly moveable member 84 causes the pivoting member 88 to pivot about the pivot member 96 such that the pivoting member 88 pushes down (in a direction opposite the arrow 108) on the extended member 104 thus moving the needle holder 50 and needle 54 towards and into the septa 38. In addition, the septa 38 is moving towards the needle 54 as the pressure builds within the container 14. Once the needle 54 punctures the septa 38, pressure is released from the container into the hollow needle and through the needle conduit 58, similar to the operation described with respect to FIGS. 1-3. Not shown in this figure is the needle conduit 58 in fluid communication with an optional reservoir 66 or an optional discharge conduit 62 attached to the bottle cap and in fluid communication with the cap cavity 42, however, those objects may included in other embodiments as modified by those of ordinary skill in the art.

In an alternative embodiment (not shown), which comprises the same mechanism as FIG. 1, a user may push the needle holder 50 through conduit 58 down into the septum 38 manually, thereby releasing any pressure in the container 14 after a reaction.

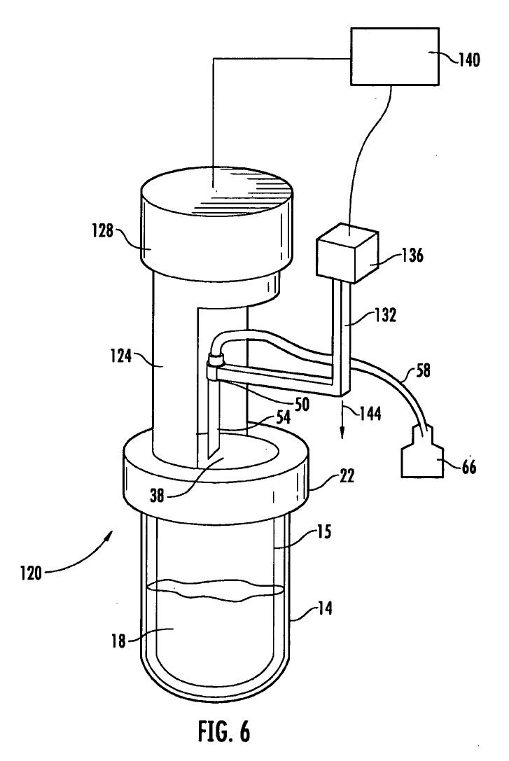

FIG. 6 discloses another embodiment of the disclosed reaction bottle. In this embodiment, the reaction bottle 120 comprises a bottle cap 22 removeably attached to the container 14. The attachment means may be by mating threaded surfaces as discussed in the previous embodiments. Located between the bottle cap 22 and container 14 is a septa 38. In communication with the septa 38 is a transmitting member 124. The transmitting member is in operational communication with a measurement transducer 128 such as a pressure transducer, for example. The hollow needle 54 is attached to a needle holder 50. A needle conduit 58 is in fluid communication with the interior of the hollow needle 54. The needle holder 50 is in operational communication with an actuating member 132. The actuating member 132 is in operational communication with an actuator 136. A processing system 140 may be in signal communication with the actuator 136 and measurement transducer 128. The processing system 140, may include, but is not limited to a computer system including central processing unit (CPU), display, storage and the like. The computer system may include, but not be limited to, a processor(s), computer(s), controller(s), memory, storage, register(s), timing, interrupt(s), communication interface(s), and input/output signal interfaces, and the like, as well as combinations comprising at least one of the foregoing. For example, the computer system may include signal input/output for controlling and receiving signals from the measurement transducer 128 as described herein. The reaction bottle 120 may operate as follows: as the pressure builds up inside the container 14, the septum 38 attempts to move towards the needle 54. The force of the septum 38 moving up translates through the transmitting member 124 to the measurement transducer 128. The measurement transducer 128 may measure the amount of force transmitted by the transmitting member 124 and communicate that information to the processing system 140. Once the force reaches a threshold value, the processing system 140 activates the actuator 136. The actuator in turn moves the actuating member 132 down in the direction of the arrow 144 a predetermined distance such that the needle 54 punctures the septum 38 and releases the excess pressure through the needle conduit 58 to a the atmosphere or to an optional reservoir 66. In other embodiments, the processing system 140 may be configured to move the needle in a direction opposite the arrow 144 and hold the needle 54 there until the processing system receives information from the measurement transducer 128 that the pressure has gone down below a threshold level, thus causing the needle to move away from the septum 38 and allow the septum to re-seal. In still another embodiment, the measurement transducer may be a movement measurement device that measures the amount of movement the transmitting member 124 moves due to the force of the septum 38. The value of the amount of movement may then be transmitted to the processing system 140. The processing system may then cause the actuator 136 to move the needle into and puncture the septum 38 when the amount of movement reaches a predetermined amount, or if the amount of movement is calibrated to an amount of pressure build up in the container, such that when the pressure reaches a first threshold value, the processing system causes the actuator to move the needle into the septum, in order to puncture the septum 38.

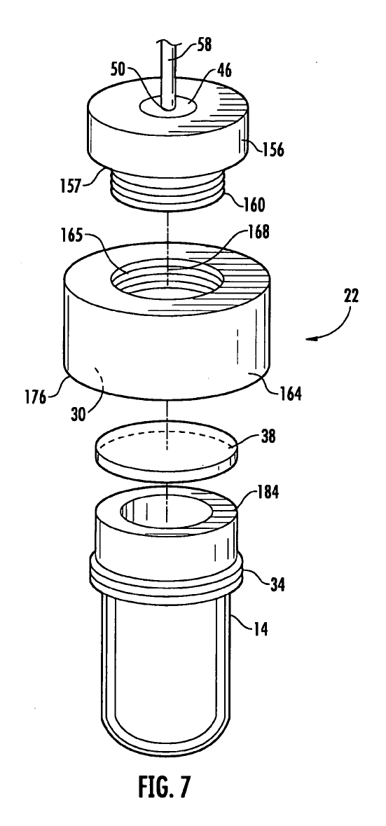

FIG. 7 shows one embodiment of how the cap 22 of the disclosed reaction bottle 10 may be assembled. The cap 22 comprises a top threaded member 156 which allows the cap top 46 (and needle holder 50 and needle 54) to move within the top threaded member 156. The top threaded member 156 has a set of male threads 160. The male threads 160 are configured to mate with the first set of female threads 168 of a lower threaded member 164. The top threaded member 156 has a lip 157 that is of a greater diameter than the threaded opening 165 of the lower threaded member 164. This insures that the top threaded member 156 cannot be screwed too far into the lower threaded member 164. A second set of female threads 172 are located near the bottom 176 of the lower threaded member. The second set of female threads 30 (not visible in this view, but seen in FIGS. 1-3) are configured to mate with a set of male threads 34 located on the container 14. The container 14 has a circular lip 184 located on the top side of the container 14. The septum 38 sits on the lip 184, between the container and the lower threaded member 164, when the lower threaded member 164 is mated with the container 14.

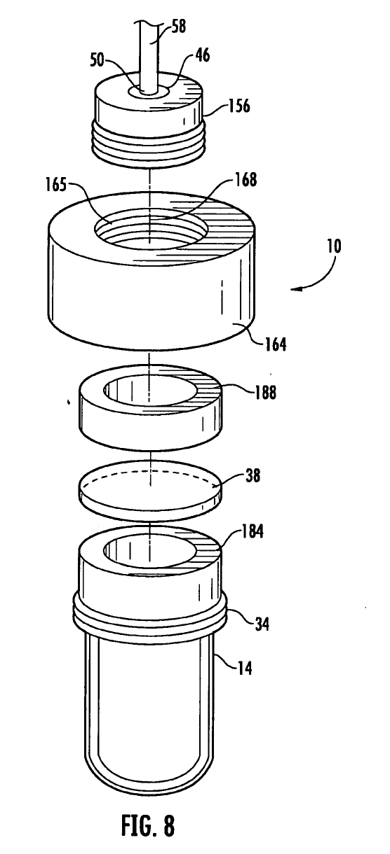

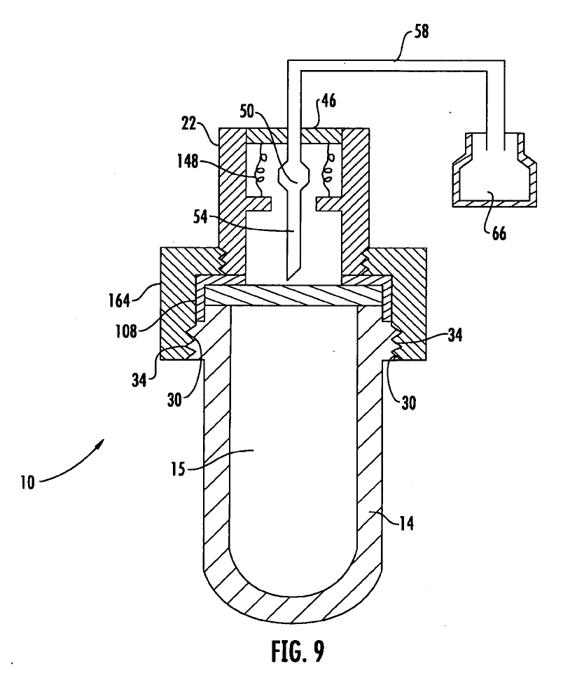

FIG. 8 shows another embodiment of how the cap 22 of the disclosed reaction bottle 10 may be assembled. In this embodiment, there is also a septum cap 188. Another difference is the top threaded member 156 does not have the lip 157, and thus the top threaded member's diameter is generally the same as the diameter of the threaded opening 165 of the lower threaded member 164. In another embodiment, the top threaded member 156 and lower threaded member 164 may manufactured as one piece. This embodiment allows one to simply use the septum cap 188, and septum 38 as a cover for the container 14, without the rest of the cap 22, and needle apparatus. This allows for easy storage, the ability to restrain toxic vapor escaping the container, and/or preventing moisture from entering the container, and safe transport of the container 14 when reactants are in it. FIG. 9 shows a generally cross-sectional view of the embodiment disclosed in FIG. 8.

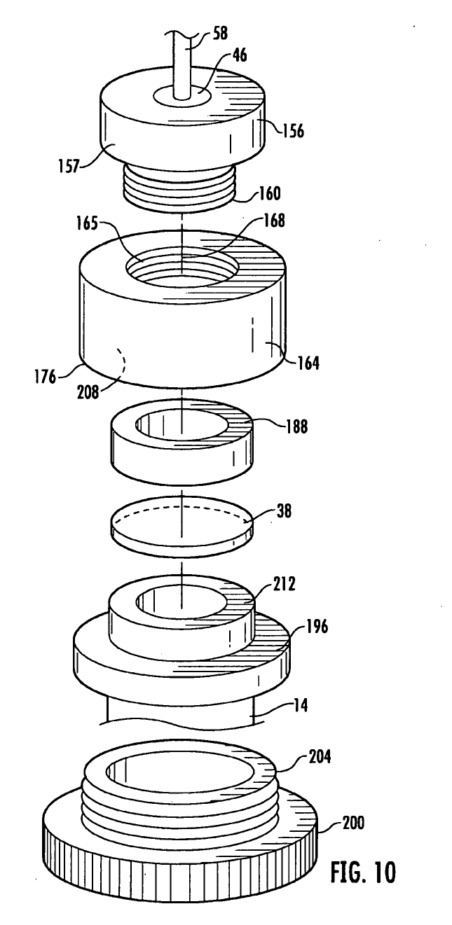

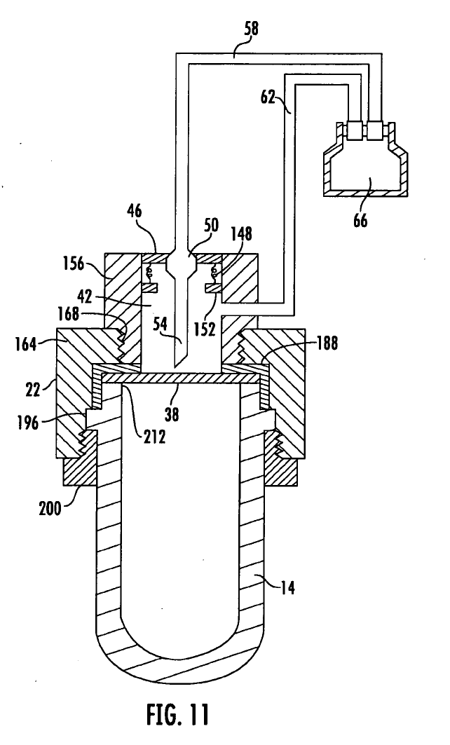

FIG. 10 shows still another embodiment of how the disclosed reaction bottle 192 may be assembled. In this embodiment, the container 14 does not have threads, but does have a circular lip 196. A threaded collar 200 slides onto the container 14 below the lip 196. The collar threads 204 are configured to lie adjacent to the lip 196. The collar threads 204 are configured to mate with a set of female threads 208 located on inside bottom 176 of the lower threaded member 164. As the lower threaded member 164 is threaded onto the collar 200, the cap assembly is held in place by the container lip 196. Again, in this embodiment, there is a septum cap 188. The lip 196 is located a fixed distance away from the container 14 opening 212. FIG. 11 shows a generally cross-sectional view of the embodiment disclosed in FIG. 10.

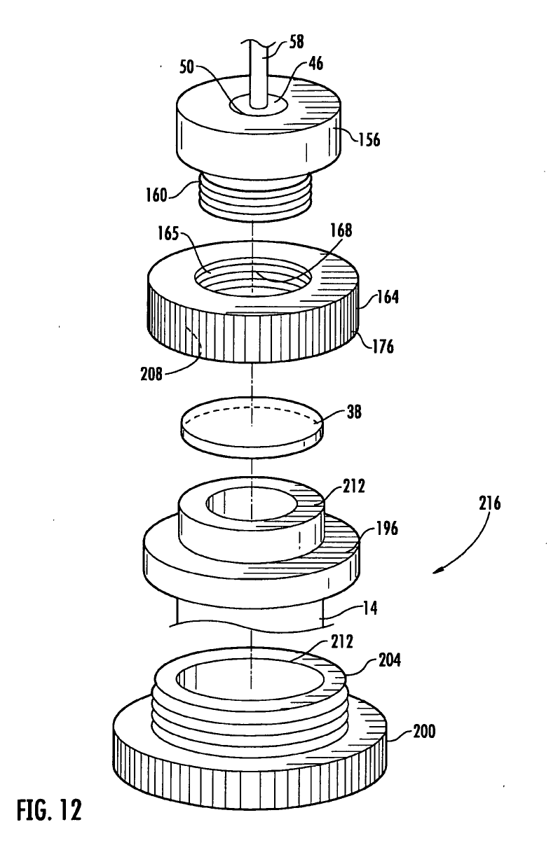

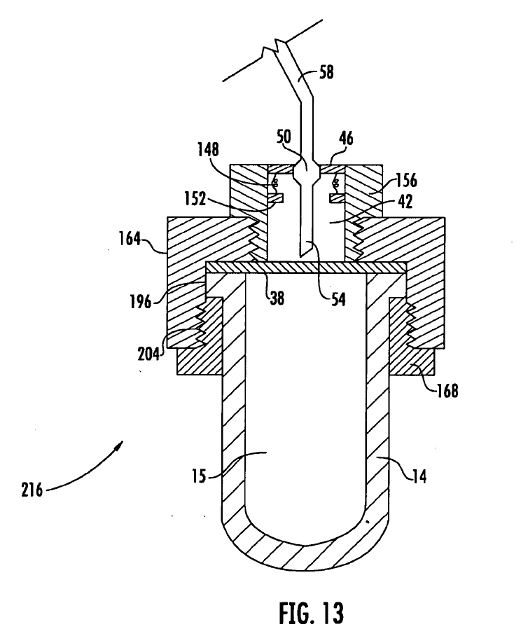

FIG. 12 shows still another embodiment of how the disclosed reaction bottle 216. In this embodiment, the container 14 does not have any threads. The container 14 does have a circular lip 196 located adjacent to the container opening 212. There is no separate septum cap in this embodiment. FIG. 13 shows a cross-sectional view of the embodiment disclosed in FIG. 12.

The advantages of the disclosed reaction bottle include that the bottle may be used with a microwave heating device. The reaction bottle will release pressure buildup in the container, when the hollow needle punctures the septa. The septa will re-seal when the needle is removed from the septa. The reaction bottle has a feed back loop, in that when pressure begins to go down, the septa will return to its original shape, and move away from the needle, at which time the septa will reseal. The reaction bottle may be used with a pressure detection transducer and a processing system. The reaction bottle is safer than reaction bottles without a pressure relief component. Compared to open vessels, the disclosed sealed reaction vessel provides following advantages for chemical reactions: a reaction can be finished in minutes instead of hours at higher temperature than boiling point of solvent; energy savings by reducing heating time from hours to minutes; energy saving by eliminating cooling condenser that is run by continuous tap water for hours; work efficiency through reducing reaction time.

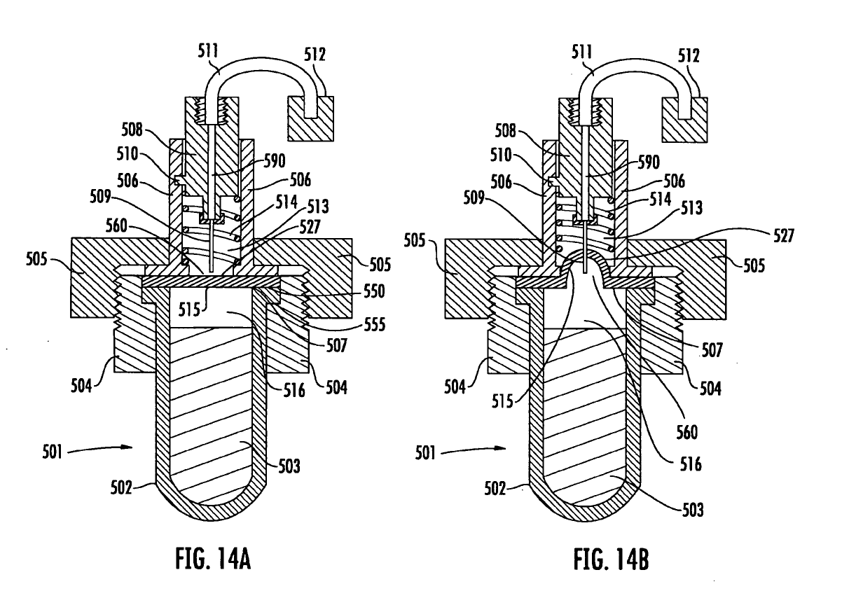

Regarding FIGS. 14A and 14B, exemplary embodiments of frontal sectional views of a reactor 501 are shown for use in a chemical reaction. The embodiment of FIG. 14A shows a chemical reactor without pressure buildup, and the embodiment of FIG. 14B shows the same chemical reactor with pressure build up. As will be explained in more detail below, FIG. 14B shows pressure build up in which a septum 507 is deformed and is punctured by a hollow needle 509, thereby releasing pressure while generally maintaining a sealed reactor.

In the exemplary embodiments of FIGS. 14A and 14B, the reactor 501 comprises a container 502 that has a container top 550, and a lip portion 555 that protrudes from the exterior surface of the container 502. Reactants 503 are placed inside of container 502. A sleeve 504 is a removably attached to the container 502 by slidably hinging to the lip portion 555 of the container to create a seal. The sleeve 504 has a threaded exterior surface and a generally cylindrical shape. Removably attached to the threaded exterior surface of the sleeve 504 is a cap 505 that has a generally cylindrical shape, a cap hole, and a threaded interior surface.

A bottle adapter 506 is configured to dispose through the cap 505 via the cap hole. The bottle adapter 506 has a generally cylindrically shape, a cavity 513, and a bottle adapter hole 560. A removably attached compression spring 514 is positioned inside the cavity 513 of the bottle adapter 506.

In the exemplary embodiment of FIG. 14C the bottle adapter 506 is shown in a three-dimensional view in which the bottle adapter 506 has a slot 570 and a groove 575 for inserting a locking pin (label 510 in FIG. 14A-B) that positions a needle adapter 508. As an alternative embodiment (not shown), the bottle adapter may have multiple slots or adjustable slots and grooves for locking and positioning a needle adapter 508.

Referring back to the exemplary embodiments of FIGS. 14A and 14B, septum 507 has a septum inner surface 515 and a septum outer surface 527. The septum outer surface 527 is positioned adjacent to the bottle adapter 506 so to expose septum outer surface 527 to the bottle adapter hole 560. The septum inner surface 515 is positioned adjacent to the container top so as to expose it to the container interior 516. It is not necessary to permanently mount the septum 507 to the bottle adapter 506 or to the container 502, thereby allowing for easy replacement of the septum 507 after a reaction.

The septum 507 may be made out of a variety of materials, such as but not limited to: 63236-C12, F1605-1.180+/−5-, sold by Saint-Gobain Performance Plastics, 11 Sicho Drive, Poestenkill, NY 12140; Septum, PTFE-faced Silicone, model no. LG-4342, sold by Wilmad-LabGlass, 1002 Harding Highway, Buena, N.J. 08310-0688; PTFE/Red Rubber Septa, PTFE/Silicone/PTFE Septa, Pre-Slit PTFE/Silicone Septa, Pre-Slit PTFE/Red Rubber Septa, PTFE Septa, PTFE/Silicone Septa, Polyethylene Septa, Polypropylene Septa, Viton® Septa, HEADSPACE 20 MM SEPTA, Natural PTFE/White Silicone Septa, Ivory PTFE/Red Rubber Septa, Gray PTFE/Black Butyl Molded Septa all sold by National Scientific Company, Part of Thermo Fisher Scientific, 197 Cardiff Valley Road, Rockwood, Tenn. 37854; PTFE/Red Rubber PTFE/Grey Butyl PTFE/Silicone PTFE/Silicone, PTFE/Silicone, PTFE/Silicone, PTFE/Moulded Butyl, PTFE/Silicone all sold by SMI-LabHut Ltd., The Granary, The Steadings Business Centre, Maisemore, Gloucestershire, GL2 8EY, UK; and LabPure® Vial Septa sold by Saint-Gobain Performance Plastics, 11 Sicho Drive, Poestenkill, N.Y. 12140. The septum 507 may be made out of material such as, but not limited to, a PTFE-faced Silicone backing. The septum may be made from natural and synthetic flexible polymers, including polytetrafluoroethylene, silicone, styrene-butadiene, polybutadinc, isoprene rubber, butyl rubber, nitrile rubber, ethylene-propylene rubber, polychloroprene rubber, acrylic rubber, epichlorhydrine rubber, ethylene-acrylic elastomer, and copolymers and mixtures thereof. This material, and other similar materials, allows the punctured hole on the septum 507 to be resealed multiple times. The septum 507 is generally designed to reseal itself at least 5 times, and up to 30 times or more, depending on the size of the hollow needle 509 and septum material.

When the threaded interior surface of the cap 505 is mated to the threaded exterior surface of the sleeve 504, the cap 505 and lip portion of the container creates a clamping like force that is exerted onto the bottle adapter and clamps the septum 507 to the container 502. This clamping further creates a seal between the septum 507 and the container interior 516.

A needle adapter 508 is removably attached to the cavity 513 of the bottle adaptor 506. A locking pin 510 is positioned on the needle adapter 508, which engages a slot that is positioned on the bottle adaptor 506 (as shown in the embodiment of FIG. 14C).

The needle adapter 508 has a needle conduit 590 for conveying fluids. The needle conduit 590 may have a threaded interior cavity portion at one end of the needle conduit 590 and an opposing end for attaching a hollow needle 509. An optional discharge conduit 511 may be removable attached to the threaded interior cavity portion of the needle conduit 590 so as to allow fluid communication between the needle conduit 590 and the discharge conduit 511. An optional reservoir 512 may be attached to the discharge conduit 511 so as to allow fluid communication between the discharge conduit 511 and the reservoir 512.

The hollow needle 509 is attached to the needle adaptor 508 so as to allow fluid communication between the needle conduit 590 and hollow needle 509. The hollow needle 509, attached to the needle adapter 508, is held in a set position by a compression spring 514 pushing against the needle adapter 508 until the locking pin 510 reaches a locking portion 580 of the groove 575 located on the bottle adapter 506.

Referring again FIG. 14C, the bottle adapter 506 will now be described in more detail below. The bottle adaptor 506 containing a slot 570 and a groove 575, in which the locking pin 510 of a needle adaptor 508 is insertably guided. Positioning the locking pin 510 within the groove 575 stabilizes the needle adaptor 508 and hollow needle 509 during deformation of a septum 507, wherein the locking pin 510 (and thus the needle adapter 508) is locked into place when the spring 514 biases the locking pin 510 into the locking portion 580 of the groove 575. An alternative embodiment of bottle adaptor contains a series of slots for setting the locking pin 510 at different groove positions. Another alternative embodiment of bottle adaptor contains a slot for setting the locking pin 510 at multiple different groove positions.

Referring again to FIG. 14A, the exemplary embodiment further shows the septum 507 at a rest state, in which the septum 507 has not been deformed by pressure build up in the container 502 (via any reaction therein). In this rest state, a user may manually push the needle adapter 508 down through the bottle adapter hole 560 and into the septum 507 in order to release any possible pressure build up that is may not be visible from deformation of septum 507. When a user manually pushes the needle adapter 508 downward, the locking pin 510 on the needle adapter 508 moves along the slot on the bottle adapter 506 (as shown in FIG. 14C) so as to safely position the hollow needle 509 through the bottle adapter hole 560, thereby puncturing the seal created by the septum and releasing any pressure in the container 502. The controlled release of any pressure build up before detaching the cap 505 from the sleeve 504 is an especially useful safety benefit. After the user has pushed down the needle adapter 508 through the bottle adapter hole 560 to release any pressure, the compression spring 514 will generally push the needle adapter 508 in an opposing direction and guide the hollow needle 509 away from the septum 507, by means of guiding the locking pin 510 through the slot 570 and into the locking position 580 of the groove 575. When in this position, the hollow needle 509 is disposed in proximity to the septum 507 that allows the hollow needle 509 to puncture the septum 507 upon a desired, relatively upward deformation of the septum 507.

Referring again to FIG. 14B, the exemplary embodiment further shows a septum deformation and a septum 507 in a punctured state. As shown, pressure in the container 502 has built up so as to deform (and/or stretch) the septum 507 through the bottle adapter hole and into the cavity 513 of the bottle adapter 506. As the septum 507 deforms it impinges upon the hollow needle 509. Once the hollow needle 509 punctures the septum inner surface 515 of the septum 507, the interior of the hollow needle 509 is in fluid communication with the container interior 516. The pressure in the container interior 516 has reached a first threshold value when the pressure causes the septum 507 to become punctured by the hollow needle 509. When the septum 507 is punctured, the pressurized gas exits the container through the hollow needle 509 and flows through the needle conduit 590. From the needle conduit 590, the pressurized gas flows through the discharge conduit 511 and exits out to the reservoir 512 or to the atmosphere. As the pressure is released, the septum 507 returns to its generally original shape, as shown in FIG. 14A. When the septum 507 has returned to a rest state, or a state in which the septum 507 is no longer punctured by the hollow needle 509, the pressure in the container interior 516 has reached a second threshold value.

The shape of the septum 507 just prior to being punctured is dependent on several factors such as the thickness of the septum 507, the particular material selected for the septum 507, and the size of the bottle adapter hole.

Several components of the reactor 501 may be configured to vary and/or predetermine the amount of pressure that is required before reaching the first threshold value. For example, the size of the bottle adapter hole that is exposed to the septum 507 may be adjusted so as to deform when the pressure in container interior 516 is between 1-500 psi. Generally, the smaller the bottle adapter hole that is exposed to the septum 507, the greater the amount of pressure that will be required to stretch and/deform the septum 507 through the bottle adapter hole and into the cavity 513. Another component that may be varied is the locking pin 510 on the needle adapter 508 and the locking portion 580 of the groove 575 on the bottle adapter 506, which allows the hollow needle 509 to be moved closer to or further away from the septum 507. The closer the hollow needle 509 is to the septum 507, the less amount of pressure will be required for the septum 507 to stretch and/or deform before being punctured by the hollow needle 509. Another component that may be varied is the thickness and/or elasticity of septum 507. A thinner septum 507 will generally stretch and/or deform under less pressure compared to a thicker septum 507 made of the same material. For example, the septum may be configured to deform when the pressure in the reaction bottle is between 150-500 psi. Of course, the septum may be configured to deform at other pressures, depending on the proposed chemical reactions and the components of the reactor.

In an alternative embodiment (not shown), a bottle adapter may contain multiple slots and grooves for setting the locking pin 510 at different positions in the multiple slots. Each slot and groove may set a locking pin at different heights protruding from the needle adapter 508, which may be calibrated to correspond to different allowed maximum pressure levels allowed in the reactor. Alternatively, multiple bottle adapters may be used in the reactor wherein each bottle adapter has a slot and a groove that positions a locking pin at different heights. A change of a bottle adapter would allow a user to set the hollow needle to different positions relative to the septum. Each bottle adapter may set a locking pin at different heights protruding from the needle adapter 508, which may be calibrated to correspond to a maximum allowable pressure levels in the reactor.

In another alternative embodiment (not shown), the needle adapter 508 may contain a threaded exterior surface and the bottle adapter 506 may contain a threaded interior surface (or vice-versa) so as to allow the needle adapter 508 to removably screw into the cavity 513 of the bottle adapter 506. This embodiment allows the hollow needle 509 to be positioned at a set distance from the septum 507, which may be calibrated to correspond to maximum allowable pressure amounts. In such an embodiment, a user may also continue to manually screw the needle adapter 508 into the bottle adapter 506 so as to move the hollow needle 509 through the bottle adapter hole and puncture the seal created by the septum, thereby releasing any pressure in the container 502.

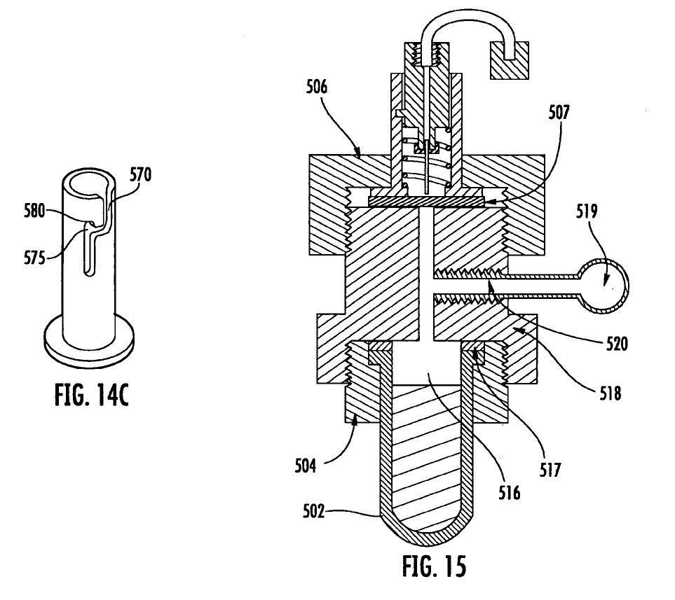

Referring to the exemplary embodiment of FIG. 15, of the reactor 501 is shown to allow a pressure gauge 519 to measure pressure build up. A cap adapter 518 is added and is configured to mate with the sleeve 504 and the cap 505 so as to allow the pressure gauge 519 to measure pressure build up inside the container interior 516. The connections of the cap, the bottle adapter, septum, needle adapter, discharge conduit, reservoir, and hollow needle are generally the same as what is described in FIGS. 14A-C. The difference is that now, as shown in the exemplary embodiment of FIG. 15, the threaded interior surface of the cap 505 is mated to the threaded exterior surface of the cap adapter 518, and the septum 507 is now positioned in between the bottle adapter 506 and the cap adapter 518.

The cap adapter 518 comprises a hollow core and a port 520 that are in fluid communication with the container interior 516. An O-ring 517 is configured to form a seal between the cap adapter 518 and container 502 when the cap adapter 518 is mated to the sleeve 504. The port 520 is configured to adapt a pressure gauge 519, which allows for a measurement of the pressure contained in the container interior 516, the hollow core of the cap adapter, and the port 520. In alternatively exemplary embodiments (not shown), the port 520 may be adapted for use of a line into the reaction container, such as when a gas needs to be added before, during or after a reaction. In alternatively exemplary embodiments (not shown), the port 520 may be removably sealed so as to allow a release of pressure without having to puncture the septum 507 or disassemble the reactor 501. In alternatively exemplary embodiments (not shown), the port 520 is configured to adapt a pressure gauge 519 with a pressure relief valve so as to allow a release of pressure without having to puncture the septum 507 or disassemble the reactor 501.

The mating between the cap 505 and the cap adapter 518 allows the cap 505 to exert a clamping like force on to the bottle adapter 506, which in turn seals the septum 507 over the hollow core of to the cap adapter 518. This allows for easy replacement of the septum 507 after a reaction, while minimizing the possibility of contamination.

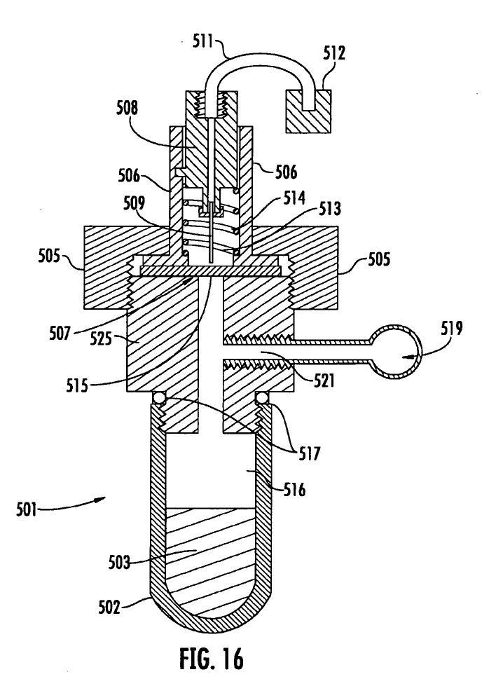

Referring to FIG. 16, therein discloses an exemplary embodiment of the reactor 501 in which the cap adapter 518 in FIG. 15 is switched for a sleeveless cap adapter 525 and the container 502 now contains a threaded interior surface. The connections of the cap, the bottle adapter, septum, needle adapter, discharge conduit, reservoir, and hollow needle are substantially the same as what is described in FIG. 14. The difference is that now, as shown in FIG. 16, the threaded interior surface of the cap 505 is mated to the threaded exterior surface of the sleeveless cap adapter 525, and the septum 507 is now positioned in between the bottle adapter 506 and the sleeveless cap adapter 525, so as to expose the septum 507 to the bottle adapter hole. The sleeveless cap adapter 525 has an upper threaded exterior surface, a lower threaded exterior surface, a port 521, and a hollow core that is in fluid communication with the container interior 516. An o-ring 517 is positioned around the circumference of the lower threaded exterior surface of the sleeveless cap adapter 525 and forms a seal between the sleeveless cap adapter 525 and the container 502 when the sleeveless cap adapter 525 is mated to the threaded interior surface of the container 502. The port 521 is configured to adapt a pressure gauge 519, with or without a pressure relief valve, which allows for a measurement of the pressure in the container interior 516, the hollow core of the sleeveless cap adapter 525, and the port 521. In an alternative exemplary embodiment, the port 521 may be adapted for use of a line into the reaction container, such as when a gas needs to be added before, during or after a reaction. In another alternative exemplary embodiment, the port 521 may be removably sealed so as to allow the release of pressure without having to puncture the septum 507 or disassemble the reactor 501.

The upper threaded exterior surface of the sleeveless cap adapter 525 engages a threaded interior of the cap 505. The mating between the cap 505 and the sleeveless cap adapter 525 exerts a clamp like force onto the bottle adapter and the septum 507, which seals the septum 507 over the hollow core of the sleeveless cap adapter 525. This allows for easy replacement of the septum 507 after a reaction, while minimizing the possibility of contamination.

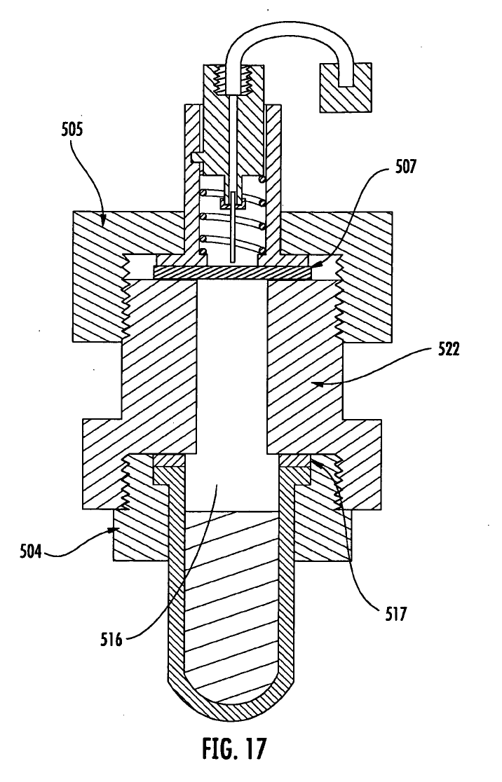

Regarding FIG. 17, an exemplary embodiment of the reactor 501 is shown in which a condenser 522 is added and is configured to mate with the sleeve 504 and the cap 505. The connections of the cap, the bottle adapter, septum, needle adapter, discharge conduit, reservoir, and hollow needle arc substantially the same as what is described in FIG. 15. The difference is that now, as shown in the exemplary embodiment of FIG. 15, the threaded interior surface of the cap 505 is mated to the threaded exterior surface of the condenser 522, and the septum 507 is now positioned in between the bottle adapter 6 and the condenser 522, so as to expose the septum 507 to the bottle adapter hole. The condenser 522 comprises a hollow core that is in fluid communication with the container interior 516. The condenser 522 allows a vapor within the hollow core to be cooled by exchanging heat between the vapor and condenser interior, then in turn between condenser exterior and atmosphere. The heat exchange may reduce internal pressure that builds up during. An O-ring 517 is configured to form a seal between the condenser 522 and container 502 when the condenser 522 is mated to the sleeve 504. The mating between the cap 505 and the condenser 522 allows the cap 505 to exert a clamping like force onto the bottle adapter, which in turn exerts a force onto the septum 507 and creates a seal between the septum 507 and the hollow core of the condenser 522 and container interior 516. This allows for easy replacement of the septum 507 after a reaction, while minimizing the possibility of contamination.

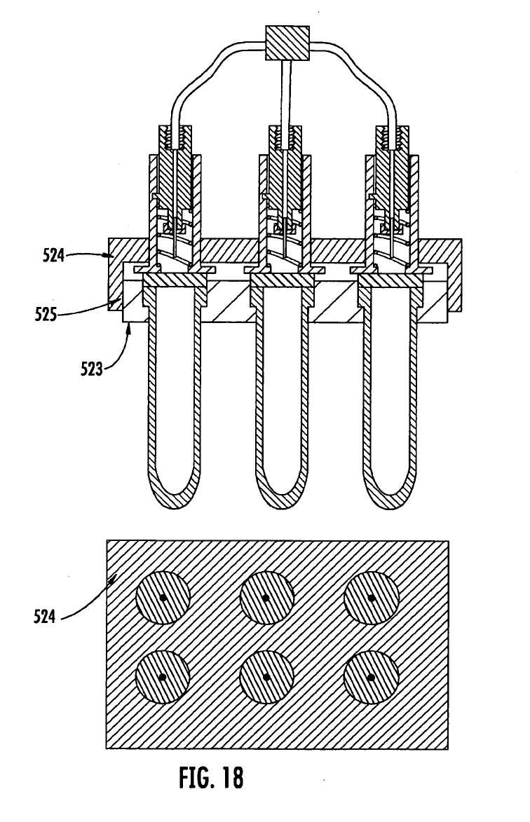

Regarding FIG. 18, an exemplary embodiment of the reactor 501 is shown in which reactor 501 is used in a parallel synthesis format. The connections are generally the same as in FIG. 14A, except that instead of a sleeve 504 and a cap 505 as described in FIG. 14A, a parallel synthesis format comprises sleeve plate 523, cap plate 524, and a locking system 525 between sleeve plate 523. The locking system 525 may include devices such as latches, clamps, screws and the like. The cap plate 524 and a sleeve plate 523 may support multiple containers and bottle adapters, and a single reservoir may be used for each reactor in the parallel synthesis format. Alternative embodiments of the parallel synthesis format (not shown) may include combinations of cooling condensers, pressure gauges, heating units, release valves, and other components described in other embodiments. The advantage of the parallel synthesis embodiment is that it allows several reactions to be carried out at the same time under similar conditions.

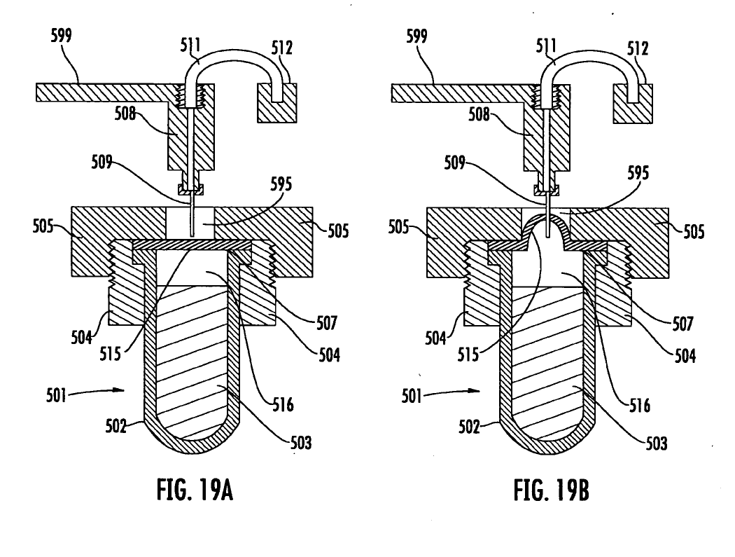

Referring to FIG. 19A-B, therein discloses an exemplary embodiment of the reactor 501 in which the bottle adapter 506 in FIG. 14A-B is switched for an arm 599 which holds the needle adapter 508. The arm 599 may be controlled manually and/or by programming so as to position the hollow needle 509 at a set distance from the septum 507, which may be calibrated to correspond to maximum allowable pressure amounts. The connections of needle adapter, discharge conduit, reservoir, and hollow needle are substantially the same as what is described in FIGS. 14A and 14B. The difference is that now, as shown in FIG. 19A, the threaded interior surface of the cap 505 is mated to the threaded exterior surface of the sleeve 504, and the septum 507 is now positioned in between the cap 505 and the container 502, so as to expose the septum 507 to a cap hole 595.

The cap 505 of the reactor 501 may be configured to vary and/or predetermine the amount of pressure that is required before reaching the first threshold value. For example, the size of the cap hole 595 that is exposed to the septum 507 may be adjusted so as to deform when the pressure in container interior 516 is between 1-500 psi. Generally, the smaller the cap hole 595 that is exposed to the septum 507, the greater the amount of pressure that will be required to stretch and/deform the septum 507 through the cap hole 595.

In another alternative embodiment (not shown), the needle adapter 508, discharge conduit 511, and reservoir 512 be built into the arm 599. In another alternative embodiment (not shown), the cap 505 and sleeve 504 are switched for a crimper cap.

It should be noted that the terms “first”, “second”, and “third”, and the like may be used herein to modify elements performing similar and/or analogous functions. These modifiers do not imply a spatial, sequential, or hierarchical order to the modified elements unless specifically stated.

While the disclosure has been described with reference to several embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiments disclosed as the best mode contemplated for carrying out this disclosure, but that the disclosure will include all embodiments falling within the scope of the appended claims.

1. A reaction bottle comprising:
a container defining a container opening and a container interior;
a septum associated with the container and configured to releasably seal the container opening;
a needle holder associated with the container, the needle holder defining a holder cavity;
a needle associated with the needle holder, the needle disposed at least partially within the holder cavity;
wherein the septum is deformable between a sealing rest state and a punctured state, said septum being deformable into puncturable impingement with an end of said needle when said septum is in said punctured state.

2. The reaction bottle of claim 1, wherein the needle is a hollow needle.

3. The reaction bottle of claim 1, wherein the holder cavity is fluidly communicable with said container interior when said septum is in said punctured state.

4. The reaction bottle of claim 1, wherein said septum is configured to deform into said punctured state in response to a buildup of a desired amount of pressure within said container interior; and optionally to return to said rest state following a release of a desired amount of pressure during said punctured state, said septum being configured to reseal any punctures caused by impingement of said hollow needle.

5. (canceled)

6. The reaction bottle of claim 2, further comprising:
a needle conduit in fluid communication with the hollow needle.

7. The reaction bottle of claim 1, further comprising:
a bottle cap removeably attachable to the container, the bottle cap having a cap top and a cap cavity.

8. The reaction bottle of claim 1, wherein the septum comprises a flexible polymer, and optionally wherein said flexible polymer is selected from the group consisting of polytetrafluoroethvlene, silicone, styrene-butadiene, polybutadine, isoprene rubber, butyl rubber, nitrile rubber, ethylene-propylene rubberpolychloroprene rubber, acrylic rubber, epichlorhydrine rubber, ethylene-acrylic elastomer, and copolymers and mixtures thereof.

9. (canceled)

10. A needle puncturing device, comprising:
a needle adapter containing a protruding member;
a needle associated with the needle adapter;
a container adapter containing at least one slot, said container adapter being configured to associate said needle adapter with a container;
wherein the protruding member is associated with the slot so as to position the needle in proximity to the container.

11. The needle puncturing device of claim 10, wherein the slot further contains at least one locking portion, wherein the protruding member inserts into the slot and maintains a locked position relative to the container via disposal within the locking portion.

12. A reaction system comprising:
a container defining a container opening and a container interior;
a septum associated with the container and configured to releasably seal the container opening;
a needle adapter containing a protruding member, the needle adapter defining a holder cavity;
a needle associated with the needle adapter, the needle disposed at least partially within the holder cavity;
a container adapter containing at least one slot, said container adapter being configured to associate said needle adapter with said container;
wherein the protruding member is associated with the slot so as to position the needle in proximity to the container;
wherein the septum is deformable between a sealing rest state and a punctured state, said septum being deformable into puncturable impingement with an end of said needle when said septum is in said punctured state.

13. The reaction system of claim 12, wherein the needle is a hollow needle.

14. The reaction system of claim 13, wherein the holder cavity defined by said hollow needle is fluidly communicable with said container interior when said septum is in said punctured state.

15. The reaction system of claim 12, wherein said septum is configured to deform into said punctured state in response to a buildup of a desired amount of pressure within said container interior; and optionally to return to said rest state following a release of a desired amount of pressure during said punctured state, said septum being configured to reseal any punctures caused by impingement of said needle.

16. (canceled)

17. The reaction system of claim 12 wherein the needle adapter and the container adapter are of separate construction, wherein the protruding member inserts into the slot of the container adapter.

18. The reaction system of claim 12, wherein the slot further contains at least one locking portion, wherein the protruding member inserts into the slot and maintains a locked position relative to the container via disposal within the locking portion.

19. The reaction system of claim 18, wherein the slot contains more than one locking portion so as to position the needle in more than one proximity to the container.

20. The reaction system of claim 12 wherein the container adaptor comprises more than one slot so as to position the hollow needle in more than one proximity to the container.

21. The reaction system of claim 13, further comprising the needle adaptor containing a conduit, wherein the conduit is in fluid communication with the hollow needle.

22. The reaction system of claim 18 wherein a spring is inserted in between the needle adapter and the container adapter so as to bias the protruding member into the locking portion.

23. The reaction system of claim 12, wherein the septum is resealable more than one time.

24. The reaction system of claim 12 further comprising a pressure gauge associated with the container.

25. The reaction system of claim 12 further comprising a condenser associated with the container.

26. A method of releasing pressure in a sealed reaction system comprising:
a) providing a reaction container with an opening and an interior, and a septum configured to releasably seal said opening; said container is associated to a container adapter where said container adapter is configured to associate a needle adapter with said container; and a needle is associated with said needle adapter;
b) placing one or more reagents and/or one or more solvents of a chemical reaction into said container;
c) positioning said septum on top of said container;
d) associating said needle with said needle adapter;
e) associating said needle adapter with said container via said container adapter to create a seal between said septum and said interior of said container;
f) providing said chemical reaction with or without heating;
g) deforming said septum by pressure generated from the inside of the container to an extent where said septum is punctured by said needle when the pressure reaches a first threshold value;
h) releasing the pressure inside said container via said needle;
i) removing said septum from contacting said needle when the pressure reaches a second threshold value; and
j) optionally repeating said deforming, releasing and removing steps until the end of the chemical reaction.
